(19) United States
(12) Patent Application Publication
(10) Pub. No.: US 2015/0067048 A1
(43) Pub. Date: Mar. 5, 2015

(54) TECHNIQUES FOR SUGGESTING CONTENT TO PROMOTE VIA A FEED

(71) Applicant: Linkedln Corporation, Mountain View, CA (US)

(72) Inventors: Ashvin Kannan, Sunnyvale, CA (US); Gyanda Sachdeva, Mountain View, CA (US); Michael Grishaver, Portola Valley, CA (US); Huining Feng, Dublin, CA (US); Baoshi Yan, Mountain View, CA (US)

(73) Assignee: Linkedln Corporation, Mountain View, CA (US)

(21) Appl. No.: 14/033,049

(22) Filed: Sep. 20, 2013

Related U.S. Application Data
(60) Provisional application No. 61/872,528, filed on Aug. 30, 2013.

(51) Int. Cl. H04L 29/06

(52) U.S. Cl. CPC H04L 65/40
USPC 709/204

(57) ABSTRACT

Techniques for suggesting content to promote via a stream are described. According to various embodiments, social activity information associated with a plurality of candidate content items posted on an online social network service may be accessed. The social activity information may describe social activity signals associated with each of the candidate content items. A specific content item may then be identified from among the plurality of candidate content items, based on the social activity signals associated with the specific content item. Thereafter an organization may be prompted to promote the specific content item on the online social network service.

### RELATED APPLICATIONS

This patent application claims the benefit of priority to U.S. Provisional Patent Application Ser. No. 61/872,528, filed on Aug. 30, 2013, which is incorporated herein by reference in its entirety.

### TECHNICAL FIELD

The present application relates generally to data processing systems and, in one specific example, to techniques for suggesting content to promote via a stream.

### BACKGROUND

Many social network services such as LinkedIn and Facebook include “feeds” or “streams” that display various content in reverse chronological order, with newer or more recent content appearing higher in the feed. Such feeds or streams are also commonly referred to as news feeds, activity feeds, network update feeds, status feeds, data feeds, news streams, activity streams, network update streams, status streams, data streams, and so on.

### BRIEF DESCRIPTION OF THE DRAWINGS

Some embodiments are illustrated by way of example and not limitation in the figures of the accompanying drawings in which:

FIG. 1 illustrates an example of a content feed of a social network service, according to various embodiments;

FIG. 2 is a block diagram showing the functional components of a social networking service, consistent with some embodiments of the invention;

FIG. 3 is a block diagram of an example system, according to various embodiments;

FIG. 4 is a flowchart illustrating an example method, according to various embodiments;

FIG. 5 illustrates an example of content item, according to various embodiments;

FIG. 6 illustrates an example of social activity information associated with a content item, according to various embodiments;

FIG. 7 illustrates an exemplary user interface that prompts an organization to promote a content item on a social network service, according to various embodiments:

FIG. 8 illustrates an example of a content feed a social network service that includes a sponsored update, according to various embodiments;

FIG. 9 is a flowchart illustrating an example method, according to various embodiments;

FIG. 10 illustrates an exemplary user interface that enables a user to specify target audience criteria, according to various embodiments;

FIG. 11 illustrates an example of member profile data associated with a particular member of a social network service, according to various embodiments;

FIG. 12 is a flowchart illustrating an example method, according to various embodiments;

FIG. 13 is a flowchart illustrating an example method, according to various embodiments;

FIG. 14 illustrates an exemplary user interface that enables a user to specify attributes of content items, according to various embodiments;

FIG. 15 is a flowchart illustrating an example method, according to various embodiments;

FIG. 16 is a flowchart illustrating an example method, according to various embodiments;

FIG. 17 illustrates an exemplary user interface that enables a user to specify pricing information for promoting content, according to various embodiments; and

FIG. 18 is a diagrammatic representation of a machine in the example form of a computer system within which a set of instructions, for causing the machine to perform any one or more of the methodologies discussed herein, may be executed.

### DETAILED DESCRIPTION

Example methods and systems for techniques for suggesting content to promote via a feed are described. In the following description, for purposes of explanation, numerous specific details are set forth in order to provide a thorough understanding of example embodiments. It will be evident, however, to one skilled in the art that the present invention may be practiced without these specific details.

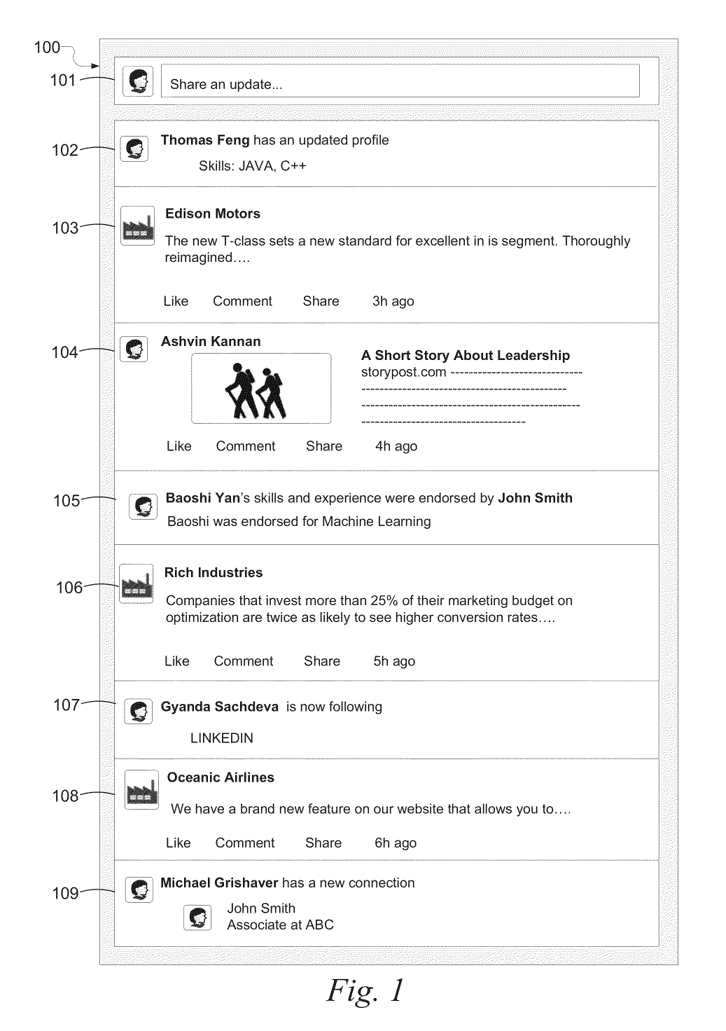

According to various exemplary embodiments described herein, a system identifies trending content on a network (e.g., the Internet) such as articles, publications, blog posts, etc., and prompts an organization to promote this content in a content feed of a social network service. For example, FIG. 1 illustrates an exemplary content feed 100 of a social network service (e.g., LinkedIn®) that is displayed to a member of the social network service when they login to the social network service. The content feed 100 includes status updates and news associated with other members of the social network service that are connected to the particular member. For example, the content feed 100 includes a status update 102 indicating that a connection has an updated profile, a status update 104 indicating that a connection has shared an article, a status update 105 indicating that the skills of a connection were endorsed by others, a status update 107 indicating that a connection has begun following a company, a status update 109 indicating that a connection has new connections, and so on. The content feed 100 also includes a user interface element 101 allowing the particular member to enter status updates, and to share these status updates with other members of the social network service (e.g., where the status updates are placed into the content feeds of other members connected to the particular member).

A social network service such as LinkedIn® also allows a member to access content associated with various interests by following a particular company, an organization, an educational institution (e.g., school or university), a particular influencer (e.g., a very important or influential member of the social network service), a particular group, and so on. For example, when a member follows a company, an educational institution, an influencer, a group, and so on, information regarding each of these interests will be included in the content feed displayed to the member. For example, suppose the member viewing the content feed 100 in FIG. 1 is following the companies “Edison Motors”, “Rich Industries”, and “Oceanic Airlines”. Accordingly, the content feed 100 includes various information (e.g., posts, shares, news, status updates, etc.) that relate to these companies, such as posts 103, 106, and 108 in the content feed 200. The content feed 100 illustrated in FIG. 1 is merely exemplary and may correspond to the main content feed displayed on the homepage of a social network service such as LinkedIn®. However, social network services such as LinkedIn® may include other content feeds, such as company content feeds associated with companies, group content feeds associated with groups, education content feeds associated with educational institutions, influencer feeds associated with influencers, member content feeds associated with members, and so on.

Accordingly, the content items included in a conventional content feed viewable by a given member are usually only sourced from other members that the given member is already connected to (e.g., status updates from other member connections), or from interests the given member is already following (e.g., news or posts from groups, companies, influencers, educational institutions, etc.). Thus, it may be difficult for a particular member to become exposed to content that is not sourced from the member's connections or the groups, educational institutions, companies, and influencers that the member is already following.

Accordingly, in various exemplary embodiments described herein, a system allows an organization to include sponsored updates in the content feeds of members of a social network service. Sponsored updates may appear similar to other updates in the content feed (e.g., updates from companies that the user is already following), and may be marked as “Sponsored” to indicate that they represent content that is being promoted in the content feed by a paying organization. Accordingly, members may be exposed to content items that they likely would not have seen otherwise. Thus, sponsored updates enable organizations to build relationships by delivering their content into the homepage feed of members beyond those who are already following their organization.

According to various exemplary embodiments, a system identifies trending content such as articles, publications, blog posts, etc., and prompts an organization to promote this content in a content feed of a social network service. For example, the system may prompt the organization to pay a fee in order to insert a sponsored update describing the content item into a content feed of a social network service. Accordingly, viewers of the sponsored update may associate the content item with the organization that promoted the content item, helping to increase publicity, brand awareness, and brand recognition for the organization. In some embodiments, the sponsored content item in the content feed may include a link allowing the viewer to follow the organization promoting the sponsored update. Thus, the system allows organizations to leverage the popularity of trending and viral articles in order to increase a number of members that follow the organization.

While various embodiments herein refer to an organization, it is understood that the aspects described herein are applicable to any company, business, institution, enterprise, entity, university, school, person, individual, etc., seeking to display content items to other users.

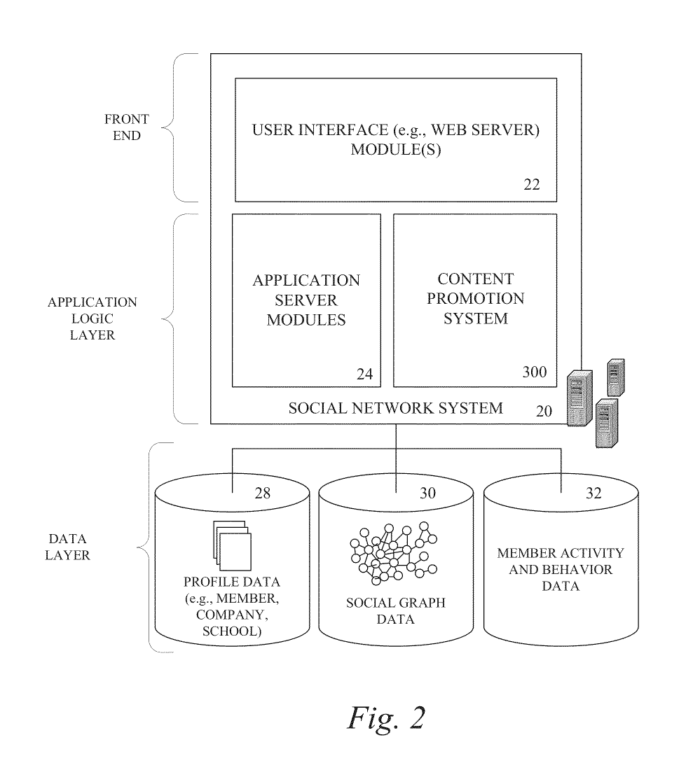

FIG. 2 is a block diagram illustrating various components or functional modules of a social network service such as the social network system 20, consistent with some embodiments. As shown in FIG. 2, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 2, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 2 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 2 by the database with reference number 32. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

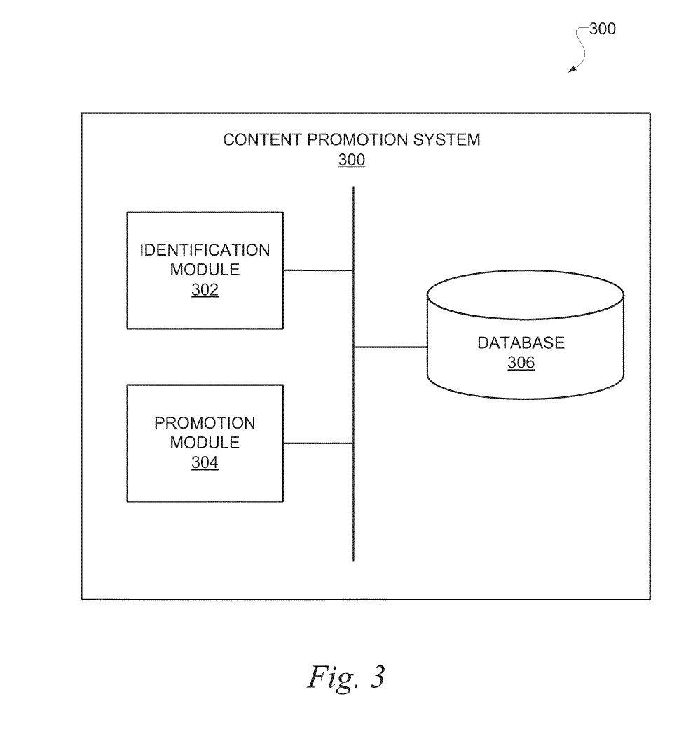

With some embodiments, the social network system 20 includes what is generally referred to herein as a content promotion system 300. The content promotion system 300 is described in more detail below in conjunction with FIG. 3.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that enables facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 3, a content promotion system 300 includes an identification module 302, a promotion module 304, and a database 306. The modules of the content promotion system 300 may be implemented on or executed by a single device such as a content promotion device, or on separate devices interconnected via a network. The aforementioned content promotion device may be, for example, a client machine or an application server.

As described in more detail below, the identification module 302 of the content promotion system 300 is configured to access social activity information associated with a plurality of candidate content items posted on an online social network service. The social activity information may describe social activity signals associated with each of the candidate content items. The promotion module 304 is then configured to identify a specific content item from among the plurality of candidate content items, based on the social activity signals associated with the specific content item.

As described herein, social activity signals may include views, likes, comments, shares, follows, views of comments, likes of comments, shares of comments, and so on. The content items referred to herein may be any type of content item, including online content items displayed in, or accessible by, a webpage or a user interface of a mobile application. Non-limiting examples of content items include advertisements, news items, blog posts, articles, publications, presentations, slideshows, documents, reviews, pictures, videos, multimedia, webpages, audio files, coupons, promotions, brochures, items posted in a content stream or content feed, notifications, emails, text or instant messages, message boards, bulletin boards, forums, profile pages (e.g., profile pages on a social network service such as LinkedIn®, such as member profile pages, influencer profile pages, company profile pages, group profile pages, etc.), and so on.

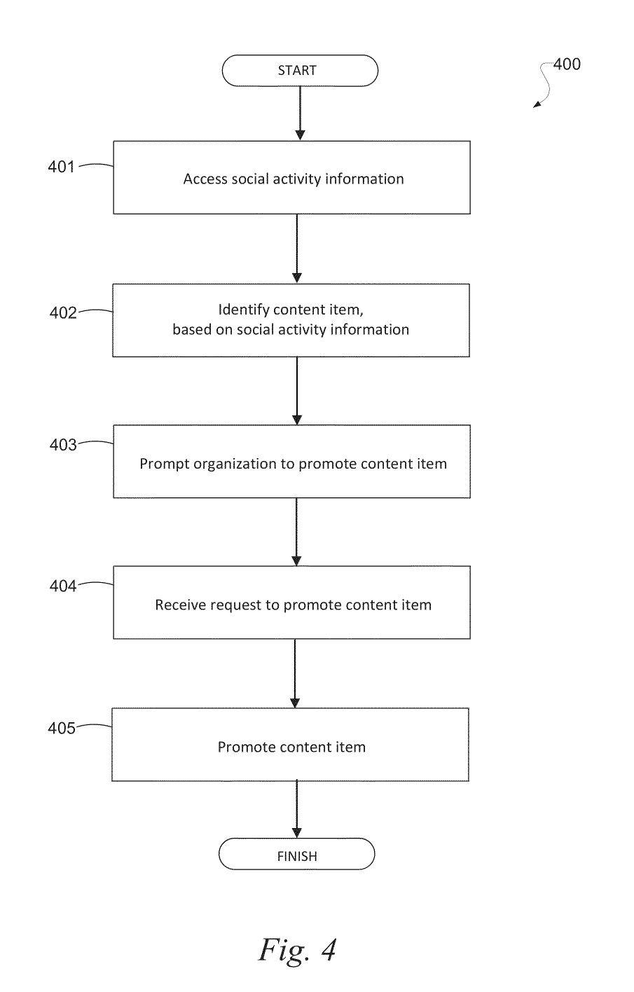

After the identification module 302 of the content promotion system 300 identifies a specific content item, the promotion module 304 is configured to prompt an organization to promote the specific content item on an online social network service. If the organization responds with a request to promote the specific content item, then the promotion module 304 will promote the specific content item by inserting a sponsored update describing the specific content item into a content feed of the online social network service. Alternatively, the promotion module 304 may automatically promote the specific content item (e.g., by inserting a sponsored update describing the content item into a content feed of the online social network service), with or without notifying the organization or receiving instructions from the organization to do so. The operation of each of the aforementioned modules of the content promotion system 300 will now be described in greater detail in conjunction with FIG. 4.

FIG. 4 is a flowchart illustrating an example method 400, according to various exemplary embodiments. The method 400 may be performed at least in part by, for example, the content promotion system 300 illustrated in FIG. 3 (or an apparatus having similar modules, such as a client machine or application server). In operation 401, the identification module 302 accesses social activity information associated with content items posted on an online social network service. As described herein, social activity information may include any data or metadata describing social activity signals associated with content items. For example, for every content item posted on a social network service, the social network service may maintain social activity information indicating how many views, likes, shares, comments, and so on, that each content item has received, as well as social activity information describing the substance of the comments associated with each of the content items. Such social activity information may be stored locally at, for example, the database 306 illustrated in FIG. 3, or may be stored remotely at a database, data repository, storage server, etc., that is accessible by the content promotion system 300 via a network (e.g., the Internet).

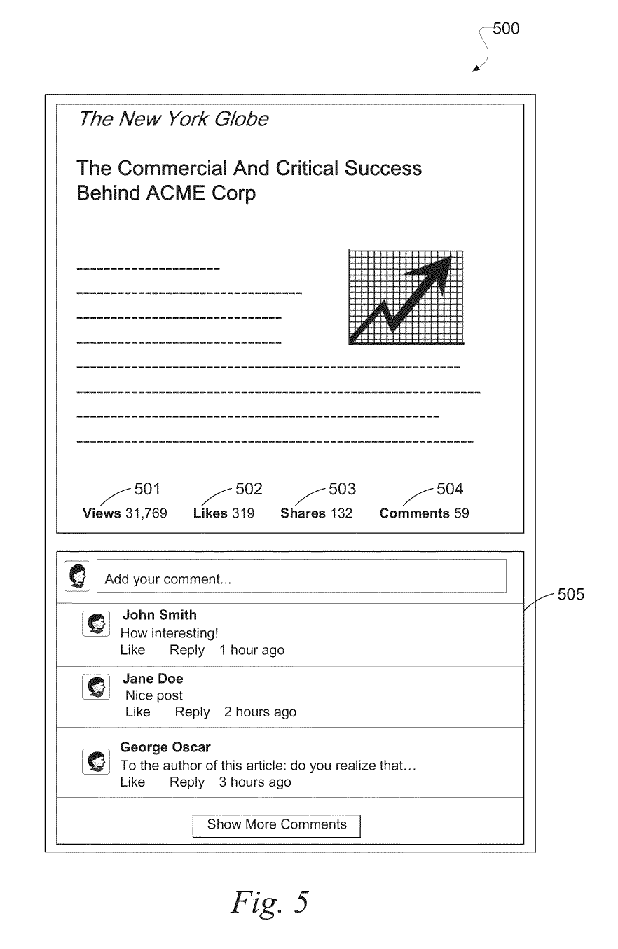

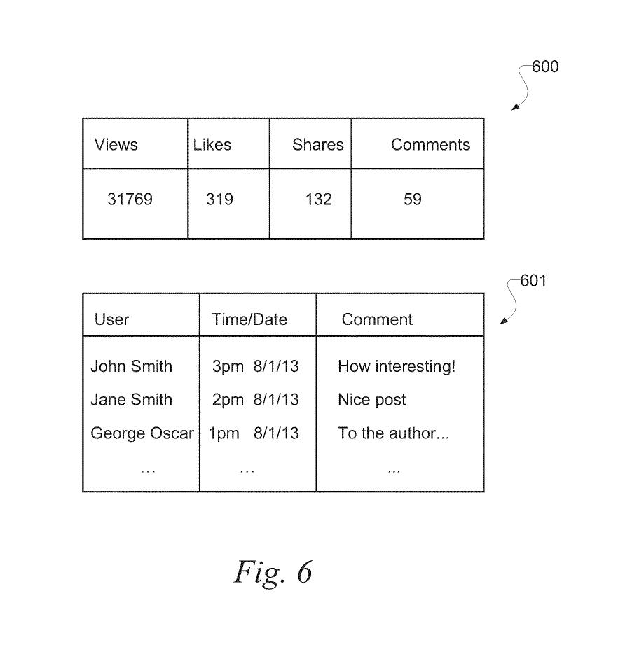

FIG. 5 illustrates an example of the content item corresponding to an article 500 describing the ACME corporation, where the article 500 includes various social activity signals including a number of views 501, a number of likes 502, a number of shares 503, a number of comments 504, and one or more comments 505. Moreover, FIG. 6 illustrates exemplary social activity information 600 and 601 associated with the article 500 illustrated in FIG. 5. The social activity information 600 describes a quantity of different social activity signals (e.g., views, likes, shares, comments, etc.) received by the article. Moreover, the social activity information 601 describes the content of comments received by the article 500, such as the identity of users that posted the comments, the times when the comments were posted, the substance of the comments, contextual information about those comments (e.g., the location of the user when they posted the comment as determined by IP address of the user's device or geo-location information from the user's device, or whether the comment was received from a mobile device or desktop device, etc.). Although not illustrated in FIG. 6, the identification module 302 may access social activity information that provides more detail with respect to other types of social activity signals, such as information describing who liked the article and when, who shared the article and when, and so on.

Referring back to the method 400 in FIG. 4, in operation 402, the identification module 302 identifies a specific trending, popular, or viral content item from among the plurality of candidate content items accessed in operation 401, based on the social activity information associated with the candidate content items. For example, the promotion module 304 may identify any content items that have at least a predetermined number of views, likes, shares, clicks, comments, and/or other social activity signals as trending content items. As another example, the identification module 302 may identify any content items that have received at least a predetermined number of social activity signals during a predetermined time interval (e.g., the last hour, the last eight hours, the last 24 hours, the last two days, etc.) as trending content items. For instance, the identification module 302 may access social activity information associated with content items periodically (e.g., at regular time intervals), in order to track the increase in social activity signals received by content items within a given time interval (e.g., the last hour, the last 8 hours, the last 24 hours, the last t1 days, etc.). Accordingly, the identification module 302 may identify any content items that have recently received a significant number of views, shares, likes, follows, or comments as trending, popular, or viral content.

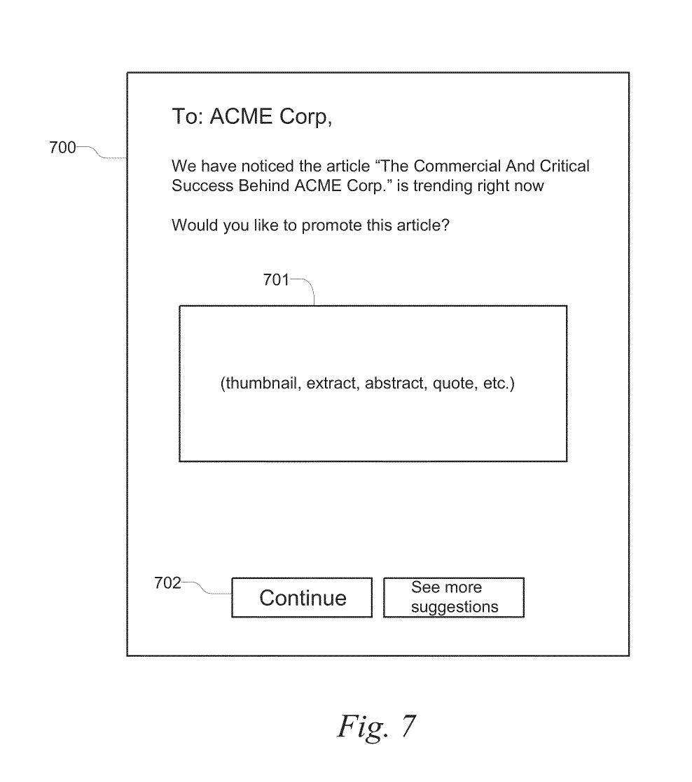

Referring back to the method 400 in FIG. 4, in operation 403, the promotion module 304 prompts an organization to promote the specific content item that was identified in operation 402 on an online social network service. For example, FIG. 7 illustrates an example of the notification 700 that identifies the article 500 (see FIG. 5) as a trending article, and that includes a thumbnail image, abstract, quote, excerpt, extract, etc. (701) of the article, and that prompts the Acme Corporation to promote this article 500. The promotion module 304 may display the notification 700 on a private organization webpage or portal of the social network service that is accessible by one or more agents (e.g., employees, representatives, advertisers, executives, marketing specialists, etc.) of the organization. Alternatively, the promotion module 304 may transmit a notification or message (e.g., an email message, a text message, an instant message, an “InMail” notification message for members of the LinkedIn® social network service, etc.) addressed to the organization or agents thereof, where the message includes the aforementioned prompt or a reference link (e.g., a URL) for accessing the prompt.

Referring back to the method 400 in FIG. 4, in operation 404, the promotion module 304 receives a request to promote the specific content item on an online social network service. For example, the promotion module 304 may detect that the “Continue” user interface element or button 702 in FIG. 7 has been selected. In operation 405 in FIG. 4, the promotion module 304 proceeds to promote the specific content item on a social network service. For example, the promotion module 304 may insert a sponsored update into a content stream, where the sponsored update refers to the specific content item and describes the specific content item being promoted. In some embodiments, the promotion module 304 may insert the specific content item itself into a content stream of the online social network service.

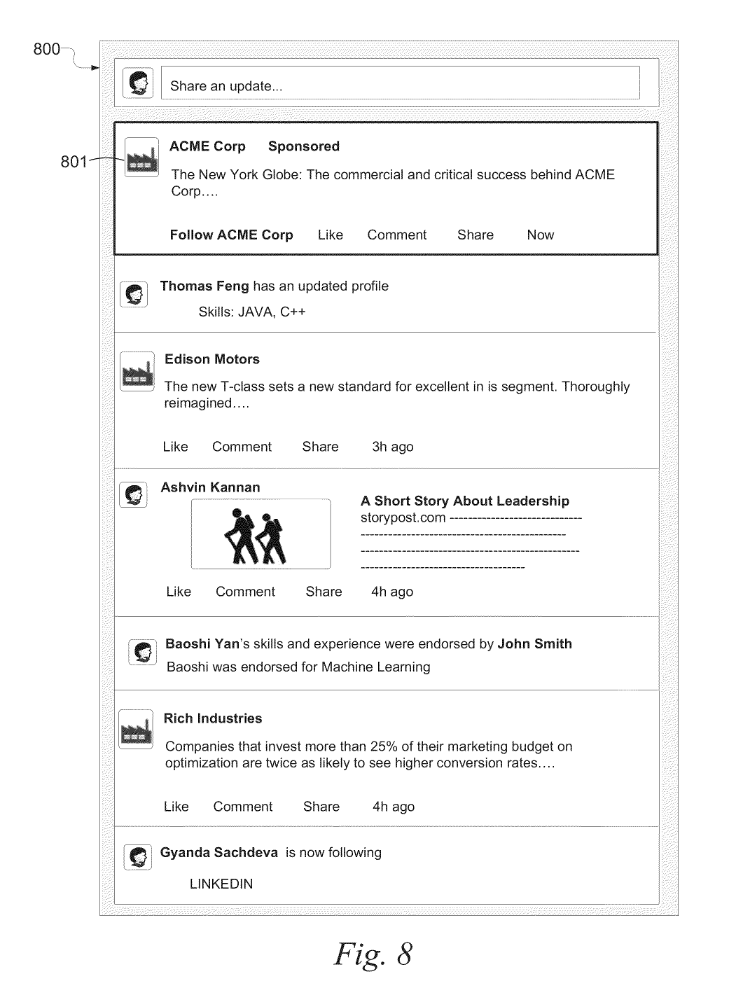

For example, FIG. 8 illustrates a content feed 800 similar to the content feed 100 illustrated in FIG. 2, where a sponsored update 801 associated with the article 500 has been inserted into the content feed 800. More specifically, the sponsored update 801 refers to the article 500 and includes a reference link for accessing the article 500. The sponsored update 801 also includes a label “Sponsored”, indicating that an organization has compensated a social network service for inserting the sponsored update 801 into the content feed 800. Moreover, the sponsored update 801 includes a link “Follow Acme Corp.” that enables a member to begin following the Acme Corp. If the member clicks on the link and proceeds to follow the Acme Corp., then future updates or posts from the Acme Corp. will be included in the content feed 800 viewable by the particular member.

In various exemplary embodiments described above, if a content item is hosted by a social network service itself, then the social network service may maintain social activity information associated with the content item in a database. Alternatively, in some embodiments, the promotion module 304 may access social activity information from content items that are not necessarily posted on a social network service. For example, the identification module 302 may crawl a network (e.g., the Internet) for content items such as articles, publications, news items, blog posts, responses posted on forums, billboards, question and answer services, and so on. In some embodiments, the promotion module 304 may identify the content items by crawling a set known third party sources or websites that are known for hosting content items, such as websites associated with news organizations, companies, important individuals, forums, billboards, question-and-answer services, blogs and bloggers, journals, clubs, and so on. In some embodiments, the identification module 302 may also access content items from other social network services.

If the content item is hosted by a third party, then the identification module 302 may crawl the information included in the content item in order to extract the aforementioned social activity information. For example, the identification module 302 may store a list of social activity keyword such as “view(s)”, “like(s)”, “share(s)”, “comment(s)”, and if the identification module 302 detects these words and adjacent numbers in a content item, the identification module 302 may infer that this information represents social activity information that indicates a number of views, likes, shares, comments, etc. the content item has received. Similarly, by crawling webpages associated with content items, the identification module 302 may identify one or more comments posted in response to the content item (e.g., such comments are typically displayed at a lower portion of the content item below the words “comments”). Accordingly, the identification module 302 may generate social activity information describing social activity signals associated with a particular content item hosted a third party website. The identification module 302 may store such social activity information (e.g. see FIG. 6) in a database. In some embodiments, the identification module 302 may determine that a content item hosted by the third party website is trending by accessing the content item periodically (e.g., at regular time intervals), in order to track the increase in social activity signals (e.g., views, shares, likes, etc.) received by the content item within a time interval (e.g., the last hour, the last eight hours, the last 24 hours, the last two days, etc.).

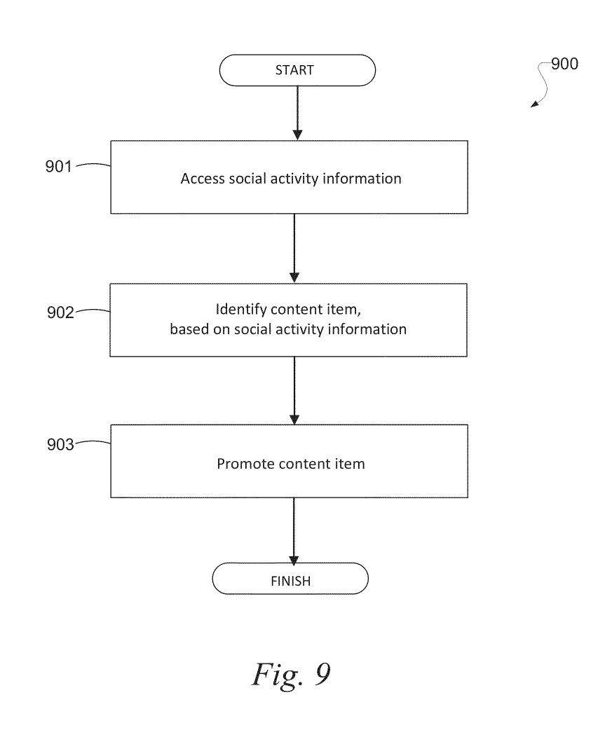

In some embodiments, the promotion module 304 may proceed to automatically promote a content item on behalf of an organization, without prompting the organization to promote the content item and/or without receiving an explicit request from the organization to promote the content item. For example, the promotion module 304 may display a user interface configured to receive a command from an organization (or an agent thereof) that content items may be identified and promoted automatically on behalf of the organization. Accordingly, the promotion module 304 may automatically promote the content item after transmitting a message to the organization indicating that the promotion module 304 is going to promote the specific content item on behalf of the organization. Alternatively, the promotion module 304 may promote a content item on behalf of the organization without transmitting any message or notification to the organization. For example, FIG. 9 is a flowchart illustrating an example method 900, consistent with various embodiments described above. The method 900 may be performed at least in part by, for example, the content promotion system 300 illustrated in FIG. 3 (or an apparatus having similar modules, such as a client machine or application server). Operations 901 and 902 in the method 900 are similar to operations 401 and 402 in the method 400 (see FIG. 4). In operation 903, the promotion module 304 automatically promotes the specific content item by inserting a status update describing the specific content item into a content stream of a online social network service.

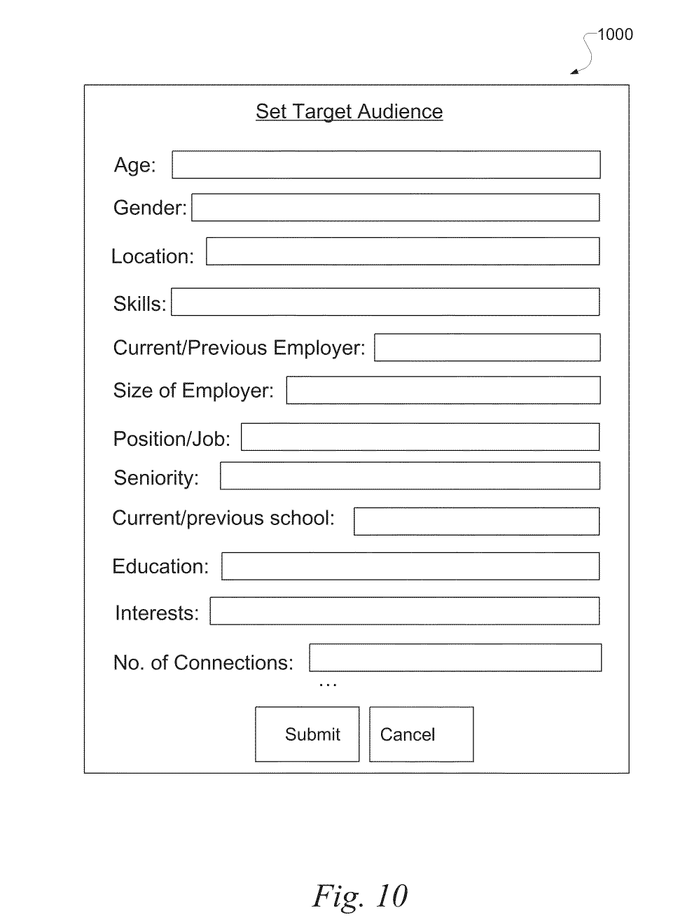

In some embodiments, the identification module 302 may identify content items that are trending generally across the memberbase of a social network service. According to other exemplary embodiments, the identification module 302 is also configured to identify content items that are trending among particular member segments, member groups, members having common attributes, target audiences, and so on. For example, in some embodiments, the identification module 302 is configured to display the user interface 1000 illustrated in FIG. 10 that allows an organization (or an agent thereof) to specify a target audience of the organization. For example, the user interface 1000 enables a user to specify attributes of a target audience such as age, gender, location, skills, current or previous employer, size of current or previous employer, current or previous position/job, seniority level, current or previous schools, education, interests (e.g., based on preferences, purchase history, viewing history, browsing history, social activity signals, membership in groups on a social network service, companies being followed, groups being followed, influencers being followed, schools or universities being followed, and so on), number of connections, identity of connections, and the like. Accordingly, based on the specified target audience, the identification module 302 may identify content items that are trending among this target audience.

In some embodiments, the identification module 302 may identify whether content items are trending among the target audience by analyzing social activity information associated with content items, where the social activity information may indicate users that publicly submitted various social activity signals. For example, if the article 500 in FIG. 5 is posted on a social network service such as LinkedIn®, then each of the social activity signals will be received from other existing members of the social network service, such as John Smith, Jane Doe, etc, as identified in the comments, likes, shares, etc. Accordingly, after accessing social activity information associated with a content item, the identification module 302 may access information associated with each of the members of the social network service that publicly submitted these social activity signals, in order to determine if these members are part of the target audience and, thus, if the content item is trending among the target audience.

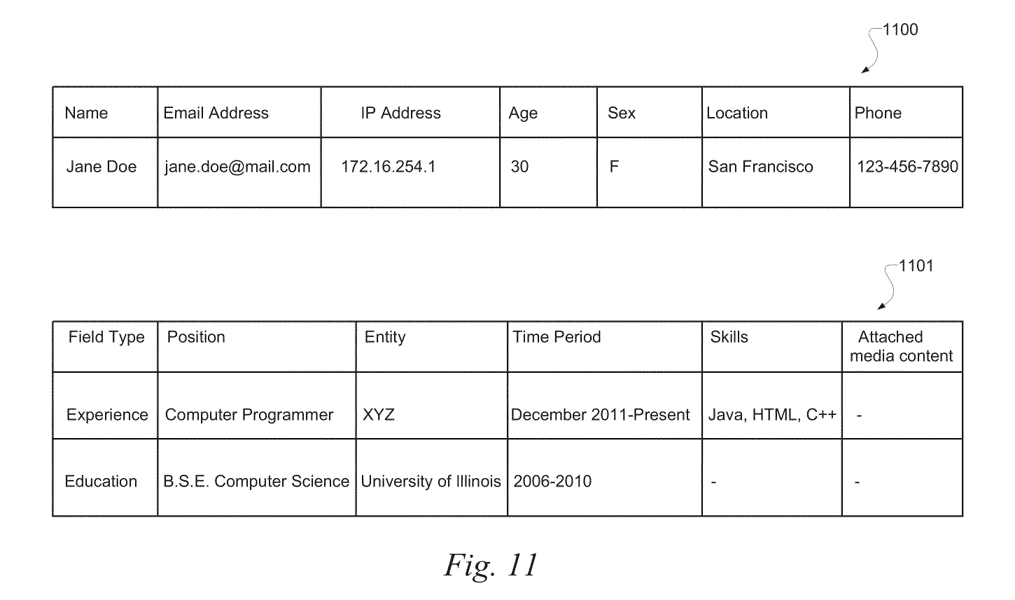

For example, since one of the comments to the article 500 was received from the user Jane Doe, the identification module 302 may access member profile data associated with a member profile of the user Jane Doe, to determine if the user Jane Doe is part of a target audience. For example, FIG. 11 illustrates an example of member profile data 1100 associated with a user Jane Doe that is maintained by social network service such as LinkedIn®, where the member profile data 1100 includes information such as name, age, gender, location, contact information (e.g., phone number, e-mail address, screen name, etc.), information regarding experience and educational positions of the member (e.g., job position/title, employer, term of employment, degree, educational institutions, skills, etc.), and so on. The member profile data 1100 illustrated in FIG. 11 is merely exemplary, and the member profile data may include other information such as groups followed, educational institutions followed, companies followed, influencers followed, and social activity signals associated with the member (e.g., content items viewed, liked, shared, commented on, substance of comments, etc.), and so on.

Accordingly, based on the member profile data of the members that have generated social activity signals associated with the article 500, the identification module 302 may identify what type of people have viewed the article, liked the article, shared the article, commented on the article, and so on. Based on this information, the identification module 302 may determine that the article is trending, popular, or viral with specific types of users. For example, the promotion module 304 may determine that the article 500 has at least a predetermined number of views, likes, shares, clicks, comments, and/or other social activity signals from users in a target audience, or that the article 500 has received at least a predetermined number of social activity signals during a predetermined time interval (e.g., the last hour, the last eight hours, the last 24 hours, the last two days, etc.) from users in the target audience, and so on. Thereafter, the promotion module 304 may prompt and organization to promote this content on the social network service, since it is a content item that is trending among the target audience of the organization.

In some embodiments, a target audience of an organization may be inferred based on advertisement targeting information previously received from the organization in connection with an advertising account or advertising campaign. For example, when organization seeks to purchase and display online advertisements on webpages, such organizations typically provide the content of the advertisements to a website and specify advertisement targeting criteria identifying the intended target audience of the advertisements. Thus, the promotion module 304 may infer the target audience of the organization based on this advertisement targeting criteria information which may have been previously received from the organization in connection with an advertising campaign.

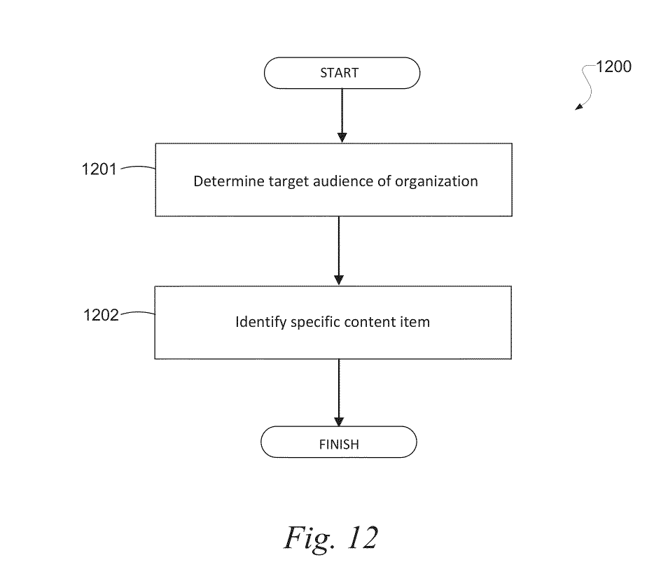

FIG. 12 is a flowchart illustrating an example method 1200, consistent with various embodiments described above. The method 1200 may be performed at least in part by, for example, the content promotion system 300 illustrated in FIG. 3 (or an apparatus having similar modules, such as a client machine or application server). In some embodiments, the method 1200 may be included in the operation 402 in FIG. 4 or the operation 902 in FIG. 9. In operation 1201, the identification module 302 determines a target audience of an organization. For example, the identification module 302 may display a user interface allowing an employee or agent of an organization to specify a target audience of the organization. Alternatively, the identification module 302 may infer the target audience based on previous advertisement targeting criteria received from the organization in connection with an advertisement campaign or advertisement account. In operation 1202 in FIG. 12, the identification module 302 identifies a specific content item (from among a plurality of candidate content items), based on social activity signals associated with the specific content item that originate from members of the target audience.

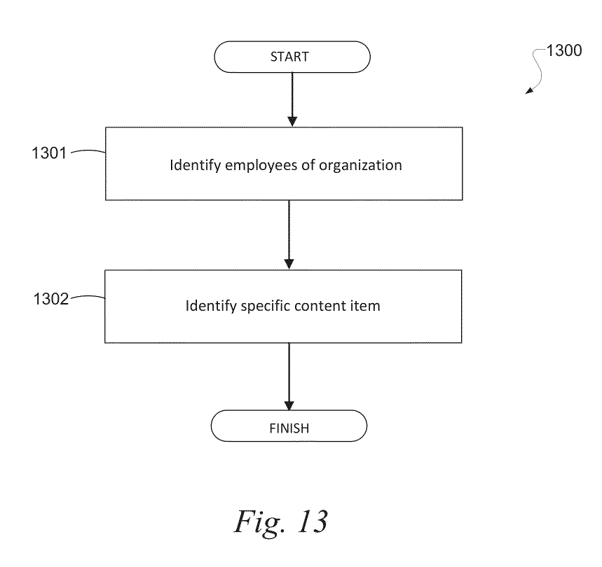

In some embodiments, the identification module 302 may identify trending content items among employees of an organization. For example, the identification module 302 may identify employees of an organization by identifying members of a social network service that have the organization listed as their current employer in their member profile data. The identification module 302 may then analyze social activity information associated with trending content items, to determine if the trending content items are actually trending among the employees of the organization. Thereafter, the promotion module 304 may prompt the organization to promote this content on the social network service, since it is a content item that is trending among the employees of the organization. For example, FIG. 13 is a flowchart illustrating an example method 1200, consistent with various embodiments described above. The method 1200 may be performed at least in part by, for example, the content promotion system 300 illustrated in FIG. 3 (or an apparatus having similar modules, such as a client machine or application server). In some embodiments, the method 1200 may be included in the operation 402 in FIG. 4 or the operation 902 in FIG. 9. In operation 1301, the identification module 302 identifies employees of an organization that are members of an online social network service. In operation 1302, the identification module 302 identifies a specific content item (from among a plurality of candidate content items), based on social activity signals associated with the specific content item that originate from the employees of the organization.

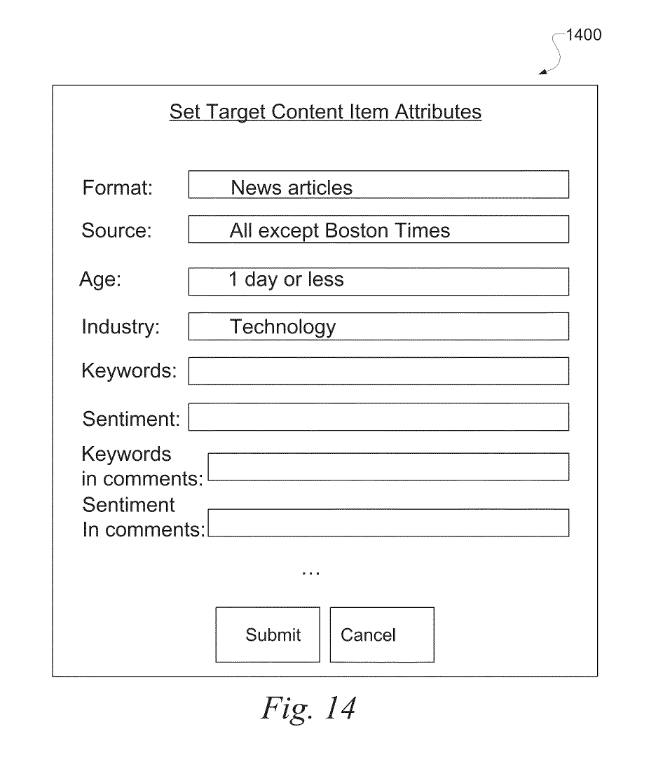

According to other exemplary embodiments, the identification module 302 is also configured to identify trending content items that satisfy particular attributes specified by an organization. For example, in some embodiments, the identification module 302 is configured to display the user interface 1400 illustrated in FIG. 14 that allows an organization (or an agent thereof) to specify a target content item attributes for content items that the organization is willing or desiring to promote. For example, the user interface 1400 enables a user to specify content item attributes such as content format (e.g., news article, blog post, etc.), content source (e.g., posts from particular groups, particular educational institutions, particular companies, particular influencers, particular members, particular third-party websites, etc.), content item age or publication date, content item industry, keywords in the content item, sentiment of the content item (e.g., positive or negative), keywords included within the comments of the content item, sentiment included within the comments of the content item, and so on. Accordingly, based on the specified target content item attributes, the identification module 302 may identify trending content items satisfying these attributes. Thereafter, the promotion module 304 may prompt the organization to promote these content items on a social network service.

In some embodiments, instead of displaying the user interface 1400 in order to receive a user specification of target content item attributes, the identification module 302 may automatically infer content item attributes for an organization. For example, the identification module 302 may infer that, for a given organization to promote the content item, that content item should not be posted by a competitor of the organization or a key employee of the a competitor of the organization, that it should be relatively new (e.g., one or two days old), that it should be related to the industry of the organization, that it should not include the name of that organization in connection with negative sentiment, and so on.

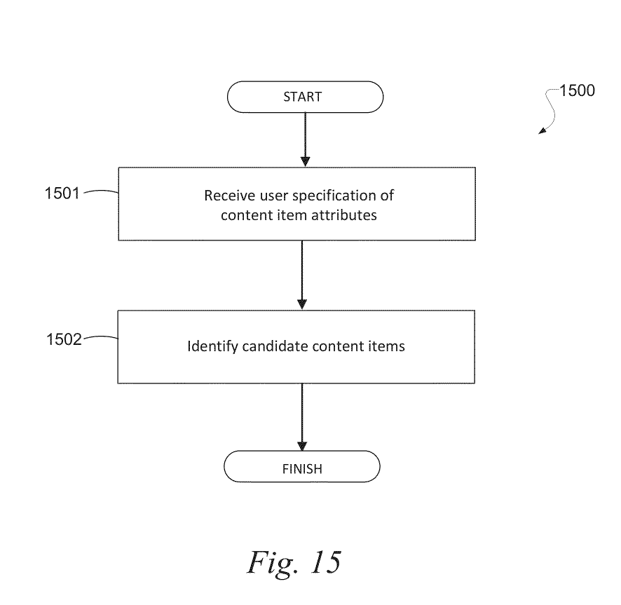

FIG. 15 is a flowchart illustrating an example method 1500, consistent with various embodiments described above. The method 1500 may be performed at least in part by, for example, the content promotion system 300 illustrated in FIG. 3 (or an apparatus having similar modules, such as a client machine or application server). In some embodiments, the method 1500 may replace the operation 401 in FIG. 4 or the operation 901 in FIG. 9. In operation 1501, the identification module 302 receives, via a user interface, a user specification of one or more content item attributes. Alternatively, in operation 1501, the identification module 302 infers content item attributes. In some embodiments, the content item attributes include content item format, content item source, content item age, content item industry, content item keywords, content item sentiment, keywords and comments, sentiment in comments, and so on. In operation 1502, the identification module 302 identifies a set of candidate content items, based on the content item attributes specified in operation 1501.

According to various exemplary embodiments, the identification module 302 may analyze the comments in trending articles, in order to determine if the comments suggest currently trending topics, issues, events, discussions, debates, news, etc. For example, perhaps an influencer posted by an influential person such as a politician includes a discussion of a civil rights court case, but a substantial majority of the comments to this article refer to a separate topic regarding gun rights. Accordingly, the identification module 302 may identify gun rights as a trending topic, and can recommend that an organization promotes content items related to this topic of gun rights.

In some embodiments, the these techniques may be applied to analyze comments in articles that have been previously posted or promoted by a particular organization or a similar organization, or articles related to an industry associated with the organization, and to analyze comments posted by a target audience or employees of the organization. For example, perhaps the Acme Corporation has promoted or posted an article describing a new online social media platform, but comments to this article posted by a target audience of the Acme Corporation refer to a separate topic regarding Internet censorship. Accordingly, the identification module 302 may identify the topic of Internet censorship as a trending topic among the target audience of the organization, and can recommend that the organization promotes content items related to this topic of Internet censorship.

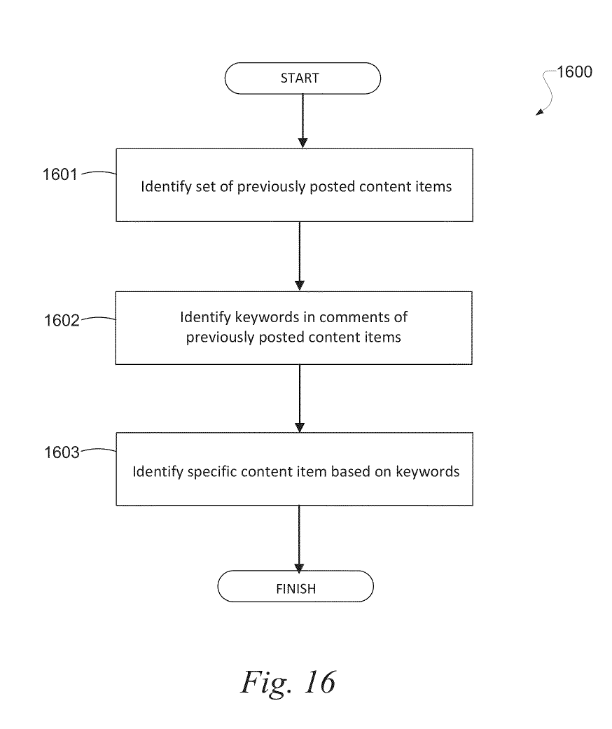

For example, FIG. 16 is a flowchart illustrating an example method 1600, consistent with various embodiments described above. The method 1600 may be performed at least in part by, for example, the content promotion system 300 illustrated in FIG. 3 (or an apparatus having similar modules, such as a client machine or application server). In operation 1601, the identification module 302 identifies a set of content items having social activity signals. For example, the identification module 302 may identify a set of content items previously posted or promoted by and organization on a social network service, or articles related to an industry associated with the organization. In operation 1602, the identification module 302 identifies keywords in comments to the article. For example, the identification module 302 may identify keywords posted by a target audience or employees of the organization. In operation 1603, the identification module 302 identifies a content item describing a topic that is associated with the keywords identified in operation 1602. The promotion module 304 may then prompt the organization to promote the content item, consistent with various embodiments described throughout.

According to various exemplary embodiments, the identification module 302 may keep track of the content items being promoted by various organizations, in order to ensure that different organizations (e.g., competitors) do not promote the same content item. In some embodiments, the content promotion system 300 may utilize a bidding system where organizations can bid to promote a particular content item, and the organization that bids the most is the only organization permitted to promote the content item. In other embodiments, the content promotion system 300 may utilize a fixed fee system, where the first organization to agree to pay the fixed fee to promote the content item is the only organization permitted to promote the content item.

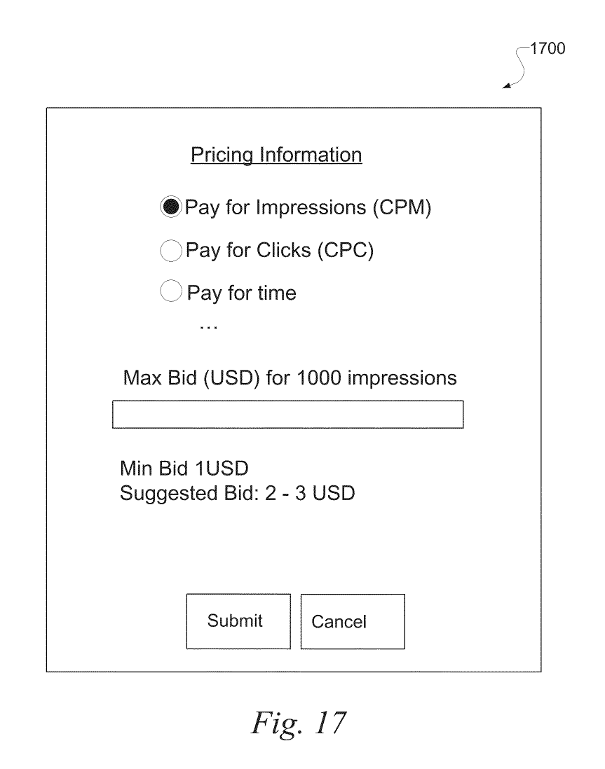

In some embodiments, the content promotion system 300 may display a user interface to display pricing information and/or receive user bidding information associated with the promotion of various content items. For example, the content promotion system 300 may display the user interface 1700 illustrated in FIG. 17 that enables an organization to select whether they would like to pay for the promotion of content items based on a number of impressions, clicks, likes, etc., that the promoted content item may receive, or a length of time during which the content item is promoted, and so on. The user interface 1700 also enables the organization to select how much it is willing to bid for a given number of impressions, clicks, likes, etc., or how much it is willing to bid to promote the content item for a given length of time, and so on. The user interface 1700 also displays the minimum bid price and suggested bid price associated with the promotion of content items. In other embodiments, the promotion of content may be based on a fixed fee model rather than an auction bidding model, in which case the user interface 1700 may display the fixed price for a given number of impressions, clicks, likes, etc., or a fixed price for promoting the content item for a given period of time, and so on.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

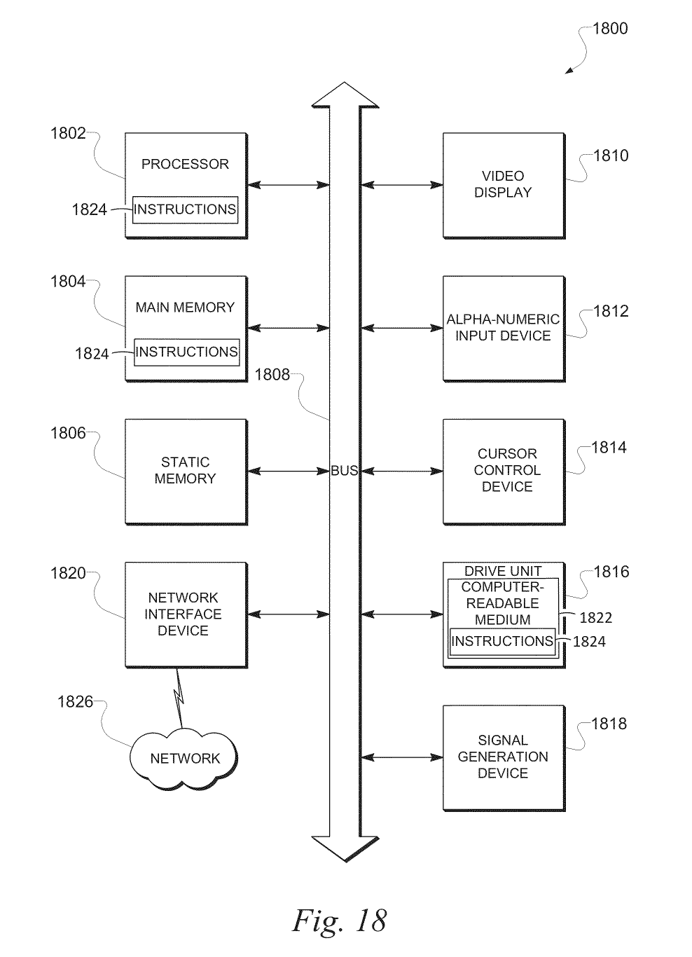

FIG. 18 is a block diagram of machine in the example form of a computer system 1800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard or a touch-sensitive display screen), a user interface (UI) navigation device 1814 (e.g., a mouse), a disk drive unit 1816, a signal generation device 1818 (e.g., a speaker) and a network interface device 1820.

### Machine-Readable Medium

The disk drive unit 1816 includes a machine-readable medium 1822 on which is stored one or more sets of instructions and data structures (e.g., software) 1824 embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media.

While the machine-readable medium 1822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMax WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
accessing social activity information associated with a plurality of candidate content items posted on an online social network service, the social activity information describing social activity signals associated with each of the candidate content items;
identifying, using one or more hardware processors, a specific content item from among the plurality of candidate content items, based on the social activity signals associated with the specific content item, the specific content item referencing an organization; and
displaying, via a user interface on a client device, a prompt prompting a user associated with the organization to promote the specific content item referencing the organization on a content feed of the online social network service.

2. The method of claim 1, further comprising:
receiving a request to promote the specific content item on the online social network service; and
promoting the specific content item by inserting an update describing the specific content item into the content feed of the online social network service.

3. The method of claim 2, wherein the update inserted into the content feed includes a label indicating that the update is a sponsored content item.

4. The method of claim 1, further comprising:
automatically promoting the specific content item by inserting an update describing the specific content item into the content feed of the online social network service.

5. The method of claim 1, wherein the specific content item is an advertisement, a news item, a publication, or an article.

6. The method of claim 1, wherein the social activity signals include views, likes, comments, shares, follows, clicks, conversions, or hover responses.

7. The method of claim 1, further comprising:
receiving, via a second user interface, a specification of a target audience associated with the organization; and
identifying the specific content item from among the plurality of candidate content items, based on social activity signals associated with the specific content item that originate from members of the target audience.

8. The method of claim 1, further comprising:
inferring a target audience associated with the organization; and
identifying the specific content item from among the plurality of candidate content items, based on social activity signals associated with the specific content item that originate from members of the target audience.

9. The method of claim 8, wherein the target audience is inferred based on advertisement targeting information previously received from the organization in connection with an advertising account.

10. The method of claim 1, further comprising:
identifying employees associated with the organization that are members of the online social network service; and
identifying the specific content item from among the plurality of candidate content items, based on social activity signals associated with the content item that originate from the employees.

11. The method of claim 1, further comprising:
receiving, via a second user interface, a specification of one or more content item attributes; and
identifying the candidate content items, based on the content item attributes.

12. The method of claim 11, wherein the content item attributes include any one of content item format, content item source, content item age, content item industry, content item keywords, and content item sentiment.

13. The method of claim 1, further comprising:
identifying the plurality of candidate content items from among content items posted by the organization on an organization-specific profile page or an organization-specific webpage associated with the organization, wherein the organization-specific profile page and the organization-specific webpage are distinct from the content feed.

14. The method of claim 1, further comprising:
identifying the plurality of candidate content items from among trending content items associated with a particular industry, wherein the organization is associated with the industry.

15. The method of claim 1, further comprising:
identifying a set of content items previously posted or promoted by the organization;
identifying keywords in comments posted by a target audience of the organization on the content items in the set; and
identifying the specific content item from among the plurality of candidate content items, based on the keywords.

16. The method of claim 1, further comprising:
selecting the organization from among a plurality of candidate organizations for the promotion of the specific content item, based on a fixed fee or bid amount submitted by the organization.

17. A system comprising:
an identification module, comprising one or more hardware processors, configured to:
access social activity information associated with a plurality of candidate content items posted on an online social network service, the social activity information describing social activity signals associated with each of the candidate content items; and
identify a specific content item from among the plurality of candidate content items, based on the social activity signals associated with the specific content item the specific content item referencing an organization; and
a promotion module configured to display, via a user interface on a client device, a prompt prompting a user associated with the organization to promote the specific content item referencing the organization on a content feed of the online social network service.

18. A non-transitory machine-readable storage medium having embodied thereon instructions executable by one or more machines to perform operations comprising:
accessing social activity information associated with a plurality of candidate content items posted on an online social network service, the social activity information describing social activity signals associated with each of the candidate content items;
identifying a specific content item from among the plurality of candidate content items, based on the social activity signals associated with the specific content item, the specific content item referencing an organization; and
displaying, via a user interface on a client device, a prompt prompting a user associated with the organization to promote the specific content item referencing the organization on a content feed of the online social network service.

19. The storage medium of claim 18, wherein the operations further comprise:
receiving, via a second user interface, a specification of a target audience associated with the organization; and
identifying the specific content item from among the plurality of candidate content items, based on social activity signals associated with members of the target audience.

20. The storage medium of claim 18, wherein the operations further comprise:
inferring a target audience associated with the organization; and
identifying the specific content item from among the plurality of candidate content items, based on social activity signals associated with members of the target audience.
